(19) United States
(12) Patent Application Publication
(10) Pub. No.: US 2016/0240859 A1
(43) Pub. Date: Aug. 18, 2016

(54) MANUFACTURING METHOD OF ELECTRODE

(71) Applicant: TOYOTA JIDOSHA KABUSHIKI KAISHA, Toyota-shi (JP)

(72) Inventor: Tomoyuki UEZONO, Toyota-shi (JP)

(73) Assignee: TOYOTA JIDOSHA KABUSHIKI KAISHA, Toyota-shi (JP)

(21) Appl. No.: 15/041,560

(22) Filed: Feb. 11, 2016

(30) Foreign Application Priority Data
Feb. 18, 2015 (JP) 2015-029948

(51) Int. Cl. H01M 4/62; H01M 4/1391; H01M 4/485; H01M 4/04

(52) U.S. Cl. CPC H01M 4/628; H01M 4/0404; H01M 4/0435; H01M 4/1391; H01M 4/485

(57) ABSTRACT

A manufacturing method of an electrode according to the present invention includes: manufacturing an electrode mixture including granules containing an electrode active material, a binder, a water-soluble polymer having an acidic functional group, and a dispersion medium containing water; and forming the electrode mixture on a current collector through rolling. The manufacturing of the electrode mixture includes forming granules containing the electrode active material, the binder, and the dispersion medium, and adding the water-soluble polymer having the acidic functional group to the granules.

### INCORPORATION BY REFERENCE

The disclosure of Japanese Patent Application No. 2015-029948 filed on Feb. 18, 2015 including the specification, drawings and abstract is incorporated herein by reference in its entirety.

### BACKGROUND OF THE INVENTION

1. Field of the Invention

The present invention relates to a manufacturing method of an electrode.

2. Description of Related Art

A non-aqueous electrolyte secondary battery such as a lithium-ion secondary battery is used in a hybrid vehicle (HV), a plug-in hybrid vehicle (PHV), an electric vehicle (EV), or the like. The non-aqueous electrolyte secondary battery includes a positive electrode and a negative electrode, which form a pair of electrodes, a separator which insulates the electrodes from each other, and a non-aqueous electrolyte. As the structure of the electrode (the positive electrode or the negative electrode) for the non-aqueous electrolyte secondary battery, a structure including a current collector formed of a metal foil or the like, and an electrode layer (electrode active material layer) which is formed thereon and contains an electrode active material is known.

In the related art, a positive electrode active material layer is manufactured, for example, by applying a paste-like electrode mixture containing a positive electrode active material such as a lithium-containing complex oxide, a conducting agent such as carbon powder, a binder such as polyvinylidene fluoride (PVDF), and a dispersion medium such as N-methyl-2-pyrrolidone (NMP), onto a current collector such as an aluminum foil, and drying and pressing the result. During the manufacturing of the positive electrode active material layer, in order to suppress the environmental impact and costs due to the use of the organic dispersion medium such as NMP, using water as the dispersion medium is considered.

In a manufacturing method of an electrode in which water is used as the dispersion medium of an electrode mixture, there is a possibility that lithium ions and the like may be eluted from an electrode active material due to the reaction of the electrode active material and the water and the pH of the electrode mixture may be increased. When the electrode mixture having an increased pH is applied onto a current collector, there is a possibility that the current collector may become corroded. There is a possibility that the corrosion of the current collector may cause an increase in battery resistance, and the like.

In Japanese Patent Application Publication No. 2011-192644 (JP 2011-192644 A), an electrode mixture containing a lithium complex metal oxide, a conducting agent, a water-soluble polymer having an acidic functional group, and water is disclosed (claim 1). As the water-soluble polymer having an acidic functional group, carboxymethyl starch, starch phosphate, alginic acid, polyacrylic acid, polymethacrylic acid, and polystyrene sulfonic acid may be employed (claim 3). By using the water-soluble polymer having an acidic functional group, an increase in the pH of the electrode mixture due to the reaction of the electrode active material and the water can be neutralized (paragraph 0011).

In Example 1 of JP 2011-192644 A, the electrode mixture is manufactured by preparing a paste containing the conducting agent (acetylene black and graphite), a thickener (carboxymethylcellulose (CMC)), and the water, adding the lithium complex metal oxide thereto and stirring the result, and adding the polyacrylic acid (PA) thereto and stirring the result. In order to effectively suppress the corrosion of the current collector caused by an increase in the pH of the electrode mixture, a sufficient amount of the water-soluble polymer having an acidic functional group needs to be present at the contact interface between the electrode mixture and the current collector. However, in the method described in JP 2011-192644 A, the water-soluble polymer having an acidic functional group is substantially homogeneously dispersed in the electrode mixture. Therefore, in order to allow a sufficient amount of the water-soluble polymer having an acidic functional group to be present at the contact interface between the electrode mixture and the current collector, there is a need to increase the addition amount of the water-soluble polymer having an acidic functional group. However, when the addition amount of the water-soluble polymer having an acidic functional group is increased, the electrode active material is coated with the water-soluble polymer having an acidic functional group, and there is a tendency toward an increase in battery resistance. Furthermore, in the method described in JP 2011-192644 A, the paste-like electrode mixture is manufactured. Therefore, the moisture content in the electrode mixture is high, and there is a possibility that the reaction itself between the electrode active material and the water in the electrode mixture may not be suppressed.

### SUMMARY OF THE INVENTION

The present invention provides a manufacturing method of an electrode, in which the electrode can be manufactured by using an electrode mixture containing water as a dispersion medium at a low cost with a low environmental impact, the reaction between the electrode active material and the water in the electrode mixture can be suppressed, an increase in the pH of the electrode mixture can be suppressed, and the corrosion of a current collector and an increase in the battery resistance due to the increase in the pH of the electrode mixture can be suppressed.

According to an aspect of the present invention, a manufacturing method of an electrode includes: manufacturing an electrode mixture including granules containing an electrode active material, a binder, a water-soluble polymer having an acidic functional group, and a dispersion medium containing water; and forming the electrode mixture on a current collector through rolling. The manufacturing of the electrode mixture includes forming granules containing the electrode active material, the binder, and the dispersion medium, and adding the water-soluble polymer having the acidic functional group to the granules.

Since an increase in the pH of the electrode mixture can effectively be suppressed and an increase in the battery resistance can effectively be suppressed, during the adding of the water-soluble polymer, an amount of the water-soluble polymer having the acidic functional group in a solid content of the electrode mixture may be 0.2 mass % to 1.0 mass %.

During the forming of the granules, the granules having a median diameter D50 of 100 μm or greater may be formed.

In the specification, the “median diameter D50” means a particle diameter in a particle diameter distribution in which the mass of particles having a diameter greater than the median diameter D50 is 50% of the mass of all of the particles.

The water-soluble polymer having the acidic functional group may be at least one type selected from the group consisting of carboxymethyl starch, starch phosphate, alginic acid, polyacrylic acid, polymethacrylic acid, and polystyrene sulfonic acid.

The manufacturing method of an electrode in the present invention may also be applied to, for example, a case where the electrode active material contains a lithium-containing complex oxide.

The manufacturing method of an electrode in the present invention may also be applied to, for example, an electrode for a non-aqueous electrolyte secondary battery.

According to the aspect of the present invention, the manufacturing method of an electrode, in which the electrode can be manufactured by using the electrode mixture containing water as the dispersion medium at a low cost with a low environmental impact, the reaction between the electrode active material and the water in the electrode mixture can be suppressed, an increase in the pH of the electrode mixture can be suppressed, and the corrosion of the current collector and an increase in the battery resistance due to the increase in the pH of the electrode mixture can be suppressed, can be provided.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1A is a schematic overall view illustrating a configuration example of a non-aqueous electrolyte secondary battery of an embodiment according to the present invention;

FIG. 1B is a schematic sectional view of an electrode laminate in the non-aqueous electrolyte secondary battery of FIG. 1A;

FIG. 1C is a schematic sectional view of an electrode of the embodiment according to the present invention;

FIG. 2 is a schematic view of a film-forming apparatus of the embodiment according to the present invention;

FIG. 3A is a flowchart illustrating a manufacturing method of a positive electrode mixture in Example 1;

FIG. 3B is a flowchart illustrating a manufacturing method of a positive electrode mixture in Comparative Example 3;

FIG. 3C is a flowchart illustrating a manufacturing method of a positive electrode mixture in Comparative Example 4;

FIG. 4A is an SEM picture of a surface of a positive electrode current collector on the formation side in Examples 3 and 4;

FIG. 4B is an SEM picture of a surface of a positive electrode current collector on the formation side in Comparative Examples 1 and 2; and

FIG. 5 is a table showing manufacturing conditions and evaluations of Examples and Comparative Examples.

### DETAILED DESCRIPTION OF EMBODIMENTS

The present invention relates to a manufacturing method of an electrode having a current collector and an electrode layer formed on at least one surface of the current collector. As the electrode, a positive electrode or a negative electrode of a battery, or the like is employed. As the battery, a non-aqueous electrolyte secondary battery such as a lithium-ion secondary battery is employed.

“Non-Aqueous Electrolyte Secondary Battery”

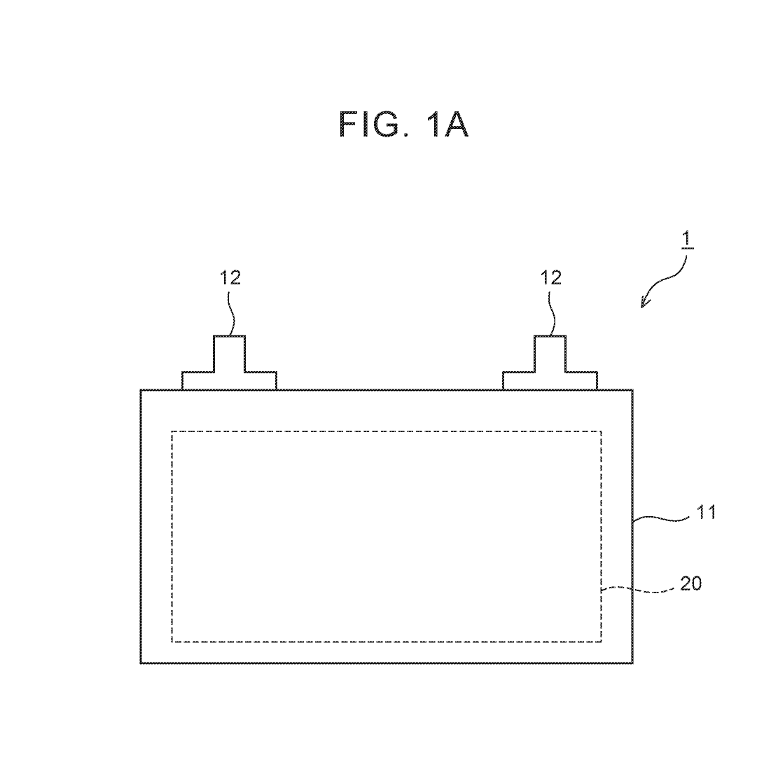

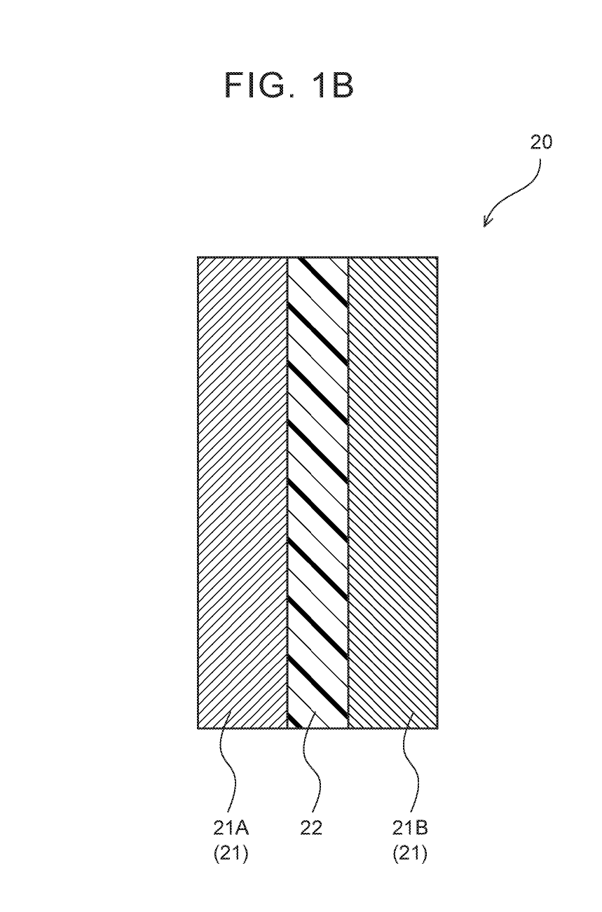

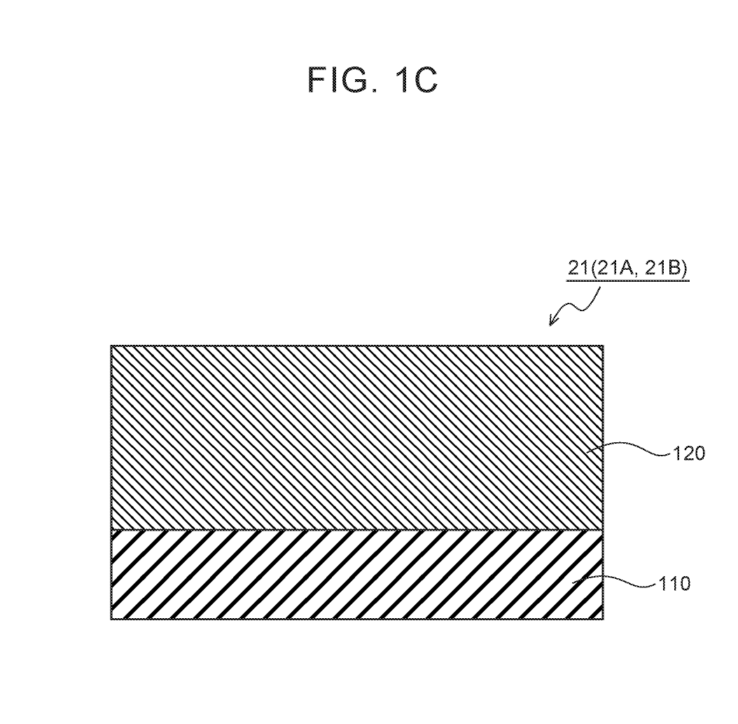

The configuration of a non-aqueous electrolyte secondary battery of an embodiment according to the present invention will be described with reference to the drawings. FIG. 1A is a schematic overall view of the non-aqueous electrolyte secondary battery of this embodiment. FIG. 1B is a schematic sectional view of an electrode laminate. FIG. 1C is a schematic sectional view of an electrode of the embodiment according to the present invention. The electrode illustrated in FIG. 1C is a positive electrode or a negative electrode in the non-aqueous electrolyte secondary battery.

As illustrated in FIG. 1A, in a non-aqueous electrolyte secondary battery 1 of this embodiment, an electrode laminate 20 and a non-aqueous electrolyte (reference numeral thereof is omitted) are accommodated in an exterior body (battery container) 11. Two external terminals (a positive terminal and a negative terminal) 12 for external connection are provided on the outer surface of the exterior body 11. As illustrated in FIG. 1B, in the electrode laminate 20, a pair of electrodes 21 are laminated with a separator 22 interposed therebetween for insulation therebetween. The pair of electrodes 21 include a positive electrode 21A and a negative electrode 21B.

As illustrated in FIG. 1C, in the electrode 21 (the positive electrode 21A or the negative electrode 21B), an electrode layer 120 is formed on at least one surface of a current collector 110. In the illustrated example, the electrode layer 120 is formed on one surface of the current collector 110. In this embodiment, the current collector 110 is a metal foil or the like, and the electrode layer 120 is an electrode active material layer containing an electrode active material (a positive electrode active material or a negative electrode active material).

As the non-aqueous electrolyte secondary battery, a lithium-ion secondary battery or the like is employed. Hereinafter, by exemplifying the lithium-ion secondary battery, main constituent elements will be described.

(Positive Electrode)

The positive electrode includes the current collector, and the electrode layer containing the positive electrode active material formed on at least one surface of the current collector. The electrode layer is formed by using an electrode mixture. As the positive electrode current collector, an aluminum foil or the like is preferably used. The positive electrode mixture contains the positive electrode active material and a binder as solid components. In a case of applying the manufacturing method of an electrode of the present invention, the positive electrode mixture further contains a water-soluble polymer having an acidic functional group as a solid component. The positive electrode mixture may further contain a conducting agent and/or a thickener as solid components, as necessary. One type or two or more types of the solid components mentioned above may be used.

The positive electrode active material is not particularly limited, and examples thereof include lithium-containing complex oxides such as LiCoO₂, LiMnO₂, LiMn₂O₄, LiNiO₂, LiNiₓCo₍₁₋ₓ₎O₂, and LiNiₓCo_{y}Mn_{(1-x-y)}O₂ (in the formula, 0<x<1, and 0<y<1). As the binder, an acrylic resin binder containing the element F (fluorinated acrylic binder), or the like is employed. As the conducting agent, a carbon material such as acetylene black (AB) or graphite is employed. As the thickener, carboxymethylcellulose (CMC) or the like is employed. As the water-soluble polymer having an acidic functional group, carboxymethyl starch, starch phosphate, alginic acid, polyacrylic acid (PA), polymethacrylic acid, polystyrene sulfonic acid, or the like is employed.

In a case of applying the manufacturing method of an electrode of the present invention, the positive electrode mixture contains one type or two or more types of dispersion mediums containing water, as a liquid component. As the dispersion medium, water, and a given dispersion medium other than water employed as necessary may be used in combination. There may be a case where the above-mentioned various solid components supplied for the manufacturing of the electrode mixture in the form of a solution or a dispersion liquid containing water, or other given solvents or dispersion media at the raw material stage. In this case, the dispersion medium in the electrode mixture contains the solvent or dispersion medium in the raw material.

(Negative Electrode)

The negative electrode includes the current collector, and the electrode layer containing the negative electrode active material formed on at least one surface of the current collector. The electrode layer is formed by using an electrode mixture. As the negative electrode current collector, a copper foil or the like is preferably used. The negative electrode mixture contains the negative electrode active material and a binder as solid components. In a case of applying the manufacturing method of an electrode of the present invention, the negative electrode mixture further contains a water-soluble polymer having an acidic functional group as a solid component. The negative electrode mixture may further contain a conducting agent and/or a thickener, as necessary. One type or two or more types of the solid components mentioned above may be used.

The negative electrode active material is not particularly limited, and a material having a lithium occlusion capability of 2.0 V or less in terms of Li/Li+ is preferably used. As the negative electrode active material, carbon such as graphite, lithium metal, lithium alloys, transition metal oxides/transition metal nitrides/transition metal sulfides capable of being doped with and dedoped from lithium ions, and combinations thereof may be employed. As the binder, a styrene-butadiene copolymer (SBR) or the like is employed. As the conducting agent, a carbon material such as acetylene black (AB) or graphite is employed. As the thickener, carboxymethylcellulose (CMC) or the like is employed. As the water-soluble polymer having an acidic functional group, carboxymethyl starch, starch phosphate, alginic acid, polyacrylic acid (PA), polymethacrylic acid, polystyrene sulfonic acid, or the like is employed.

In a case of applying the manufacturing method of an electrode of the present invention, the electrode mixture of the negative electrode active material contains one type or two or more types of dispersion mediums containing water, as a liquid component. As the dispersion medium, water, and a given dispersion medium other than water employed as necessary may be used in combination. There may be a case where the above-mentioned various solid components contain water, or a given solvent or dispersion medium at the raw material stage, and are supplied for the manufacturing of the electrode mixture in the form of a solution or a dispersion liquid. In this case, the dispersion medium in the electrode mixture contains the solvent or dispersion medium in the raw material.

(Non-Aqueous Electrolyte)

As the non-aqueous electrolyte, a well-known non-aqueous electrolyte may be used, and a liquid, gel-like, or solid non-aqueous electrolyte may be used. For example, a non-aqueous electrolyte obtained by dissolving a lithium-containing electrolyte in a mixed solvent of a high-permittivity carbonate solvent such as propylene carbonate or ethylene carbonate and a low-viscosity carbonate solvent such as diethyl carbonate, methyl ethyl carbonate, or dimethyl carbonate is used. As the mixed solvent, for example, ethylene carbonate (EC)/dimethyl carbonate (DMC)/ethyl methyl carbonate (EMC) is preferably used. As the lithium-containing electrolyte, for example, lithium salts such as LiPF₆, LiBF₄, LiClO₄, LiAsF₆, Li₂SiF₆, LiOSO₂CₖF₍₂ₖ₊₁₎ (k is an integer of 1 to 8), LiPFₙ{CₖF₍₂ₖ₊₁₎}₍₆₋ₙ₎ (n is an integer of 1 to 5, and k is an integer of 1 to 8), and a combination thereof may be employed.

(Separator)

The separator may be a film which electrically insulates the positive electrode and the negative electrode from each other and allows lithium ions to pass through, and a porous polymer film is preferably used. As the separator, for example, a porous film made of polyolefin such as a porous film made of polypropylene (PP), a porous film made of polyethylene (PE), or a laminated type porous film of polypropylene (PP) and polyethylene (PE) is preferably used.

(Exterior Body (Battery Container))

As the exterior body, a well-known exterior body may be used. As the shapes of the secondary battery, there are a cylindrical shape, a coin shape, a square shape, a film shape (laminated shape), and the like, and the exterior body may be selected according to a desired shape.

“Manufacturing Method of Electrode”

The manufacturing method of an electrode of the present invention includes a process (A) of manufacturing the electrode mixture formed of granules containing the electrode active material, the binder, the water-soluble polymer having an acidic functional group, and the dispersion medium containing water, and a process (B) of forming the electrode mixture on the current collector through rolling.

In the manufacturing method of an electrode of the present invention, the process (A) includes a process (AX) of forming granules containing the electrode active material, the binder, and the dispersion medium, and a process (AY) of adding the water-soluble polymer having an acidic functional group to the granules.

In the manufacturing method of an electrode of the present invention, since the electrode mixture containing water is used as the dispersion medium, the electrode can be manufactured at a lower cost with a lower environmental impact compared to a case of using an organic dispersion medium.

In the manufacturing method of an electrode of the present invention, the electrode mixture formed of the granules is used. Since the electrode mixture formed of the granules has a lower moisture content than a paste-like electrode mixture, the reaction itself between the electrode active material and the water in the electrode mixture is suppressed, and thus, the elution of lithium ions and the like from the electrode active material due to the reaction between the electrode active material and the water in the electrode mixture and a corresponding increase in the pH of the electrode mixture can be suppressed.

In the manufacturing method of an electrode of the present invention, the electrode mixture containing the water-soluble polymer having an acidic functional group is used. Therefore, even when the elution of lithium ions and the like from the electrode active material due to the reaction between the electrode active material and the water in the electrode mixture and a corresponding increase in the pH of the electrode mixture slightly occur, the increase in the pH thereof can be neutralized by the water-soluble polymer having an acidic functional group. As a result, the corrosion of the current collector, a corresponding increase in the battery resistance, and the like can be suppressed.

In the manufacturing method of an electrode of the present invention, after the granules containing the electrode active material, the binder, and the dispersion medium are formed, the water-soluble polymer having an acidic functional group is added to the granules. Therefore, the water-soluble polymer having an acidic functional group can effectively be allowed to be present on the surface of each particle of the granules. Therefore, even when the addition amount of the water-soluble polymer having an acidic functional group is low, the water-soluble polymer having an acidic functional group can effectively be allowed to be present at the contact interface between the electrode mixture and the current collector. In the manufacturing method of an electrode of the present invention, since the addition amount of the water-soluble polymer having an acidic functional group is low, the electrode active material can be prevented from being excessively coated with the water-soluble polymer having an acidic functional group, and thus, an increase in the battery resistance due to the coating of the electrode active material can be prevented.

According to the present invention, with compatibility with the above-described operational effect, the manufacturing method of an electrode, in which the electrode can be manufactured by using the electrode mixture containing water as the dispersion medium at a low cost with a low environmental impact, the reaction between the electrode active material and the water in the electrode mixture can be suppressed, an increase in the pH of the electrode mixture can be suppressed, and the corrosion of the current collector and an increase in the battery resistance due to the increase in the pH of the electrode mixture can be suppressed, can be provided.

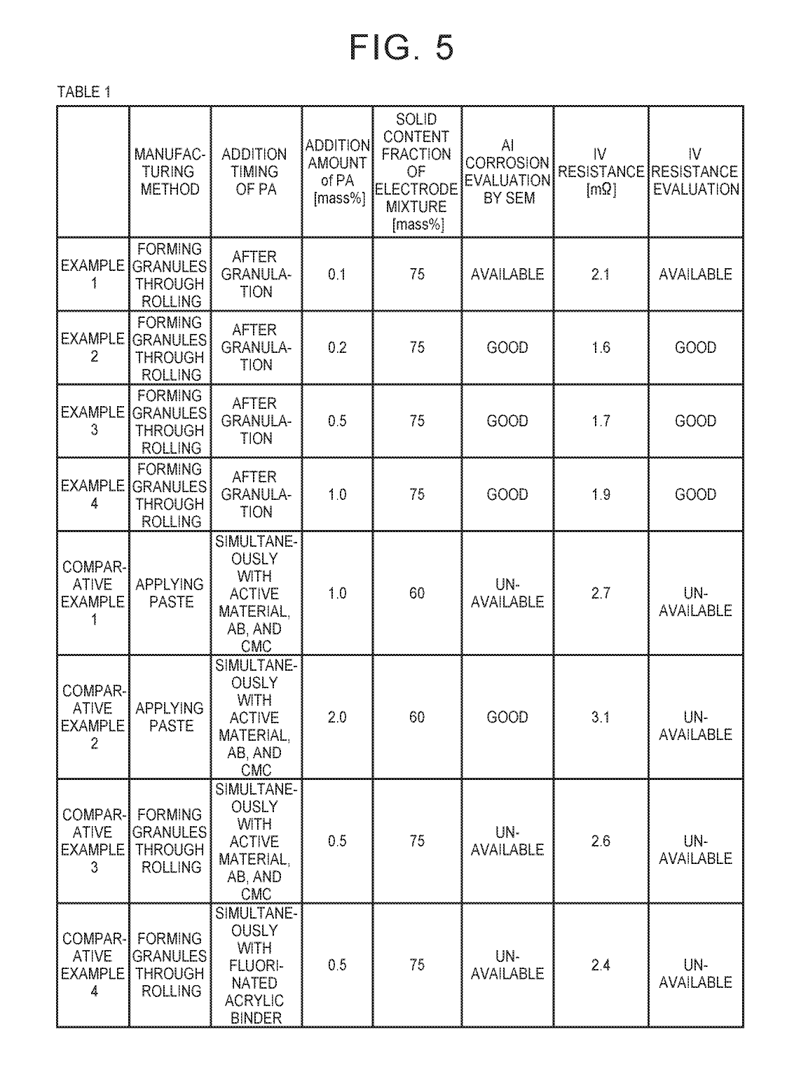

Since an increase in the pH of the electrode mixture can effectively be suppressed and an increase in the battery resistance can effectively be suppressed, in the process (AY), it is preferable that the amount of the water-soluble polymer having an acidic functional group in the solid content of the electrode mixture is 0.2 mass % to 1.0 mass % (refer to the section “Examples”, which will be described later, and Table 1 in FIG. 5).

In the process (AX), it is preferable that granules having a median diameter D50 of 100 μm or greater are formed. Since the median diameter D50 of the granules is 100 μm or greater, the specific surface area of the granules can be reduced. Therefore, even when the addition amount of the water-soluble polymer having an acidic functional group is a relatively low amount, the surface of each particle of the granules can be properly coated with the water-soluble polymer having an acidic functional group, and thus, the corrosion of the current collector can effectively be suppressed.

It is preferable that the water-soluble polymer having an acidic functional group is at least one type selected from the group consisting of carboxymethyl starch, starch phosphate, alginic acid, polyacrylic acid, polymethacrylic acid, and polystyrene sulfonic acid.

Since a problem of an increase in the pH of the electrode mixture caused by ion elution from the electrode active material due to the reaction between the electrode active material and the water can be solved, the present invention is appropriate for, for example, a case in which the electrode active material contains a lithium-containing complex oxide.

(Positive Electrode)

The process (A) will be specifically described by exemplifying the positive electrode of the lithium-ion secondary battery. As the positive electrode current collector, an aluminum foil or the like is preferably used. In a case of applying the manufacturing method of the present invention, the positive electrode mixture containing the positive electrode active material, the binder, and the water-soluble polymer having an acidic functional group as the solid components is used. The positive electrode mixture may further contain the conducting agent and/or the thickener as necessary. One type or two or more types of the solid components mentioned above may be used.

The positive electrode active material is not particularly limited, and examples thereof include lithium-containing complex oxides such as LiCoO₂, LiMnO₂, LiMn₂O₄, LiNiO₂, LiNiₓCo₍₁₋ₓ₎O₂, and LiNiₓCo_{y}Mn_{(1-x-y)}O₂ (in the formula, 0<x<1, and 0<y<1). As the binder, an acrylic resin binder containing the element F (fluorinated acrylic binder), or the like is employed. As the conducting agent, a carbon material such as acetylene black (AB) or graphite is employed. As the thickener, carboxymethylcellulose (CMC) or the like is employed. As the water-soluble polymer having an acidic functional group, carboxymethyl starch, starch phosphate, alginic acid, polyacrylic acid (PA), polymethacrylic acid, polystyrene sulfonic acid, or the like is employed.

The positive electrode mixture contains one type or two or more types of dispersion mediums containing water, as the liquid component. As the dispersion medium, water, and a given dispersion medium other than water employed as necessary may be used in combination. There may be a case where the above-mentioned various solid components are supplied for the manufacturing of the electrode mixture in the form of a solution or a dispersion liquid containing water, or other given solvents or dispersion media at the raw material stage. In this case, the dispersion medium in the electrode mixture contains the solvent or dispersion medium in the raw material.

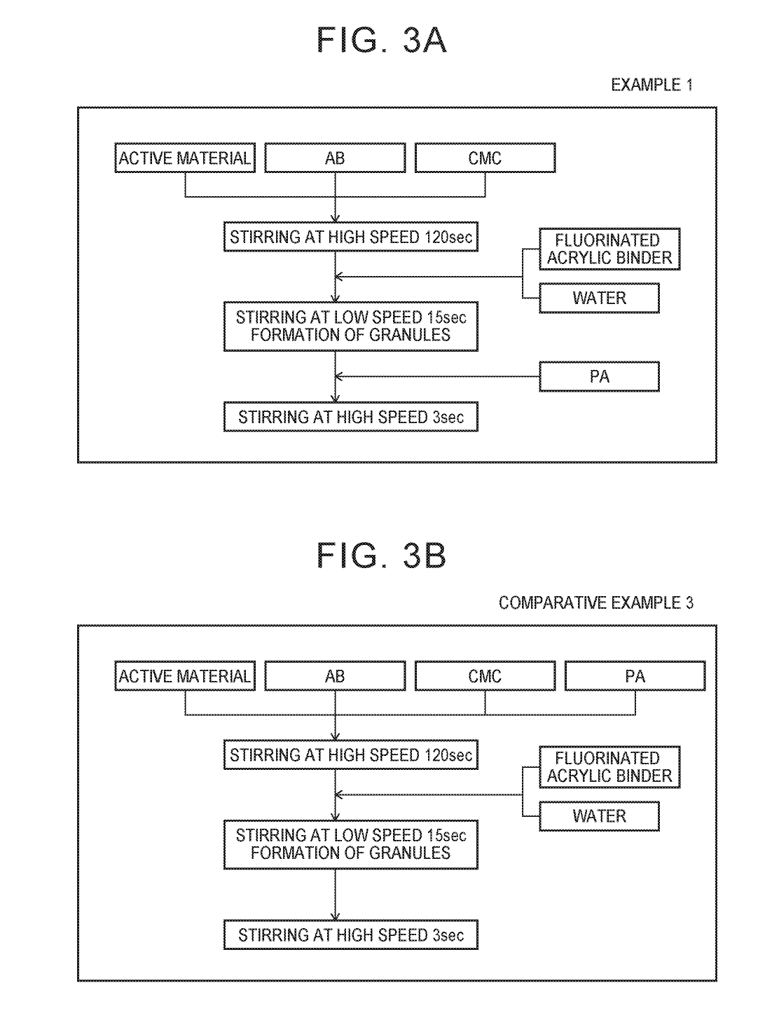

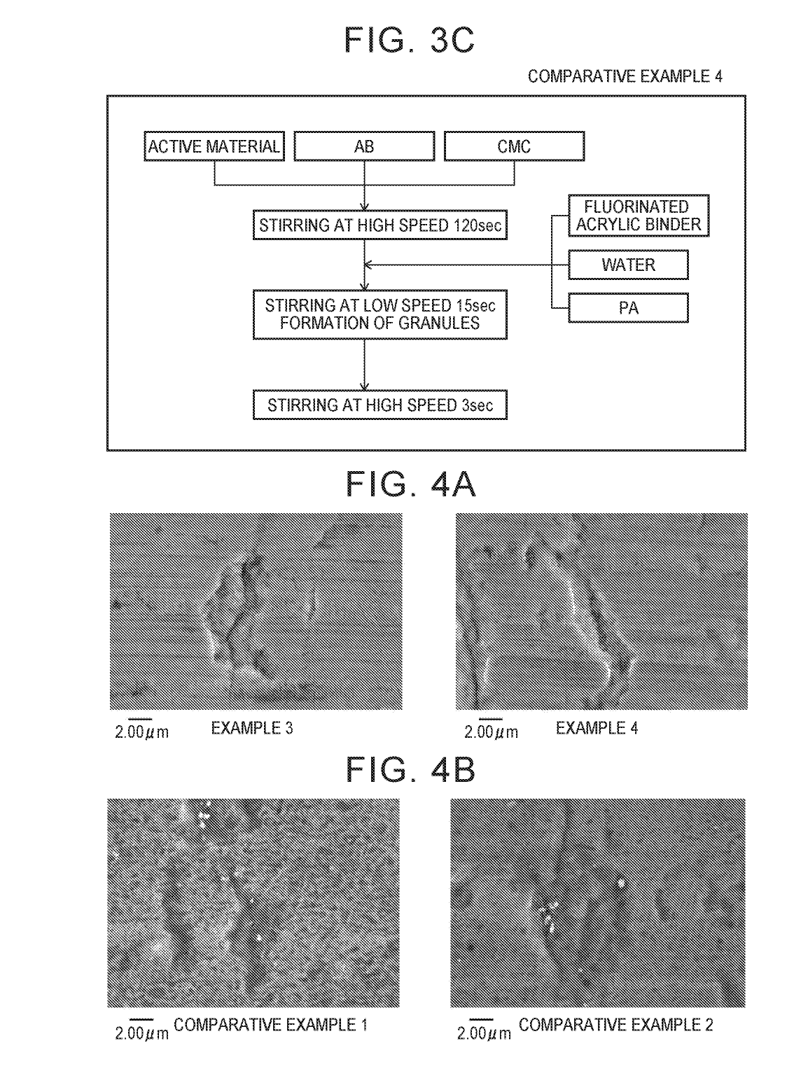

In a case where the positive electrode mixture contains the positive electrode active material, the conducting agent, the binder, the thickener, the water-soluble polymer having an acidic functional group, and the water, an example of a flowchart of a manufacturing method of the electrode mixture is illustrated in FIG. 3A (Example 1 described later). In this example, the positive electrode active material is the lithium-containing complex oxide, the conducting agent is acetylene black (AB), the thickener is carboxymethylcellulose (CMC), the binder is the acrylic resin binder containing the element F (fluorinated acrylic binder), and the water-soluble polymer having an acidic functional group is polyacrylic acid (PA).

First, the positive electrode active material (the lithium-containing complex oxide), the conducting agent (AB), and the thickener (CMC) are supplied to a well-known stirring apparatus, the result is stirred, the binder (the fluorinated acrylic binder) and the water are thereafter added thereto, and the result is stirred, thereby obtaining granules (process (AX)). In this process, it is preferable that the particle size distribution of the powder-like raw material, stirring conditions in each stirring process, and the like are adjusted to obtain granules having a median diameter D50 of 100 μm or greater.

The stirring speed and the stirring time in each stirring process are not particularly limited. As illustrated in the figure, it is preferable that the stirring (first stirring) of the positive electrode active material (the lithium-containing complex oxide), the conducting agent (AB), and the thickener (CMC) is performed at a relatively high speed for a long period of time. It is preferable that the stirring (second stirring) after the addition of the binder (the fluorinated acrylic binder) and the water is performed at a relatively low speed for a short period of time.

The flow of the process (AX) illustrated in FIG. 3A is an example, and in the process (AX), as long as the granules containing the positive electrode active material, the binder, and the water can be manufactured the mixing composition of the granules and mixing order the granules can be appropriately changed, with the exception of the mixing composition of the water-soluble polymer (PA) and mixing order of the water-soluble polymer (PA).

As described above, in the process (AX), after forming the granules containing the positive electrode active material (lithium-containing complex oxide), the conducting agent (AB), the binder (fluorinated acrylic binder), the thickener (CMC), and the water excluding the water-soluble polymer (PA) having an acidic functional group are formed, the water-soluble polymer (PA) having an acidic functional group is added (process (AY)). It is preferable that the water-soluble polymer (PA) having an acidic functional group is added in the form of powder. Since an increase in the pH of the electrode mixture can effectively be suppressed and an increase in the battery resistance can effectively be suppressed, in the process (AY), it is preferable that the amount of the water-soluble polymer having an acidic functional group in the solid content of the electrode mixture is 0.2 mass % to 1.0 mass % (refer to the section “Examples”, which will be described later, and Table 1 in FIG. 5).

As illustrated in the figure, it is preferable that stirring is performed after the addition of the water-soluble polymer (PA) having an acidic functional group. Accordingly, the water-soluble polymer (PA) having an acidic functional group can be substantially uniformly adhered to the surface of each particle of the granules. The stirring speed and the stirring time in this stirring process are not particularly limited. As illustrated in the figure, it is preferable that the stirring (third stirring) after the addition of the water-soluble polymer (PA) having an acidic functional group is performed at a relatively high speed for a short period of time.

In the above-described manner, the positive electrode mixture containing the positive electrode active material (lithium-containing complex oxide), the conducting agent (AB), the binder (fluorinated acrylic binder), the thickener (CMC), the water-soluble polymer (PA) having an acidic functional group, and the water is manufactured. The solid content fraction of the positive electrode mixture is, for example, 70% to 90%.

[Film-Forming Apparatus]

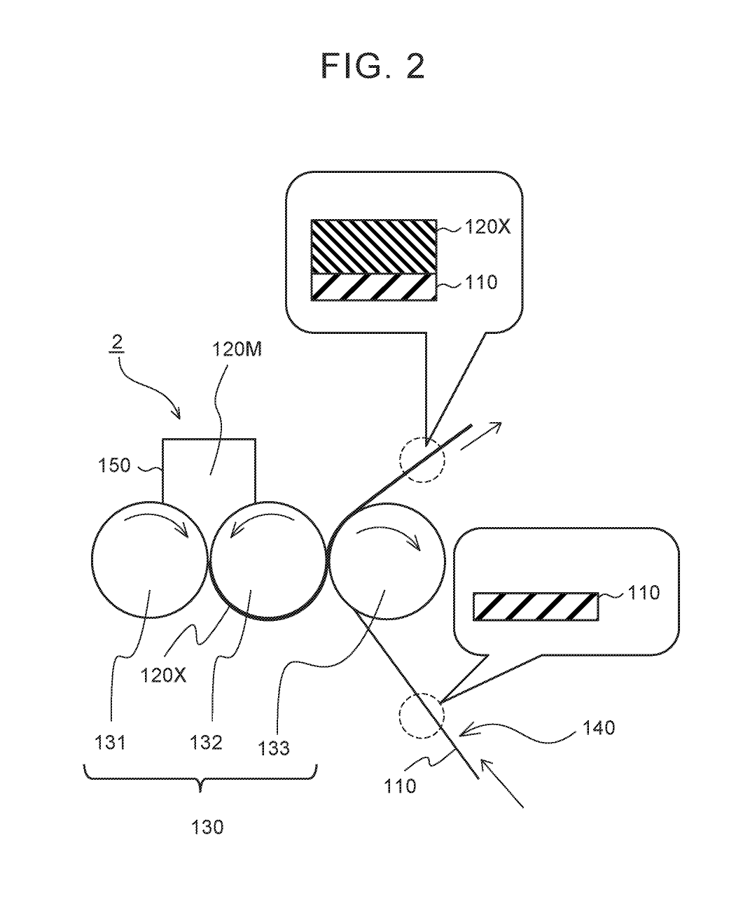

An embodiment of a film-forming apparatus used in the process (B) will be described with reference to the drawings. FIG. 2 is a schematic view of the film-forming apparatus of the embodiment.

A film-forming apparatus 2 illustrated in FIG. 2 is an apparatus which forms an electrode mixture 120M on the current collector 110 through rolling.

The film-forming apparatus 2 includes a roll unit 130 constituted by a plurality of rolls which are disposed adjacent to one another, current collector supplying means 140 for supplying the current collector 110 to the roll unit 130, and electrode mixture supplying means 150 for supplying the electrode mixture 120M to the roll unit 130.

In the illustrated example, the roll unit 130 is constituted by a first roll 131, a second roll 132, and a third roll 133, which are disposed adjacent to one another. In FIG. 2, the rotational direction of each of the rolls is indicated by arrows. In the illustrated example, the current collector 110 is supplied between the second roll 132 and the third roll 133 from the lower side of the figure by the current collector supplying means 140. In the illustrated example, the electrode mixture 120M is supplied between the first roll 131 and the second roll 132 from the upper side by the electrode mixture supplying means 150.

The electrode mixture 120M is formed of granules including the dispersion medium and has a higher solid content fraction than that of a paste-like electrode mixture. The solid content fraction of the electrode mixture 120M is, for example, 70 mass % to 90 mass %. In this embodiment, since the solid content fraction of the electrode mixture 120M is relatively high, as the electrode mixture supplying means 150, a hopper that supplies the electrode mixture 120M in a dry manner, or the like is preferable.

As the current collector supplying means 140, well-known current collector supplying means may be used. For example, the current collector supplying means 140 is a transport system including a feed roll which feeds the current collector 110, one or more transport rolls, and the like.

The electrode mixture 120M supplied between the first roll 131 and the second roll 132 is compressed between the first roll 131 and the second roll 132 and becomes an electrode mixture layer 120X. The electrode mixture layer 120X is supplied between the second roll 132 and the third roll 133 by the rotation of the second roll 132, and adheres to the current collector 110 supplied between the second roll 132 and the third roll 133 under compression.

The configuration of the film-forming apparatus 2 is merely an example, and can be appropriately changed in design.

Since the electrode mixture 120M contains the dispersion medium, a drying apparatus (not illustrated) which dries and removes the dispersion medium is provided at the rear stage of the film-forming apparatus 2, as necessary. In this case, the electrode mixture layer 120X becomes the electrode layer 120 after a drying process performed by the drying apparatus. As the drying apparatus, a well-known drying apparatus may be used, and an infrared drying furnace which performs heating and drying using infrared light, or the like is employed. Drying conditions such as a drying temperature can be appropriately set, and the amount of necessary energy for drying is lower than that in a case of using a paste-like electrode mixture.

As described above, according to this embodiment, the manufacturing method of an electrode, in which the electrode can be manufactured by using the electrode mixture containing water as the dispersion medium at a low cost with a low environmental impact, the reaction between the electrode active material and the water in the electrode mixture can be suppressed, an increase in the pH of the electrode mixture can be suppressed, and the corrosion of the current collector and an increase in the battery resistance due to the increase in the pH of the electrode mixture can be suppressed, can be provided.

Hereinafter, Examples and Comparative Examples according to the present invention will be described.

### Examples 1 to 4 and Comparative Examples 1 to 4

In each of Examples 1 to 4 and Comparative Examples 1 to 4, a lithium-ion secondary battery was manufactured by changing a manufacturing method of a positive electrode. Conditions except for the manufacturing method of a positive electrode were common.

(Positive Electrode)

<Raw Materials and Mixing Composition of Positive Electrode>

As the positive electrode active material, LiNi_{1/3}Mn_{1/3}Co_{1/3}O₂ (“T2” manufactured by Sumitomo Metal Mining Co., Ltd.) as a ternary lithium complex oxide was prepared. As the conducting agent, acetylene black (AB) (“HS-100L” manufactured by Denka Company Limited) was prepared. As the thickener, carboxymethylcellulose (CMC) (“MAC800LC” manufactured by Nippon Paper Industries Co., Ltd.) was prepared. As the binder, an acrylic resin binder containing the element F (fluorinated acrylic binder) (manufactured by JSR Corporation) was prepared. As the water-soluble polymer having an acidic functional group, a powder polyacrylic acid (PA) (“JURYMER AC-10LHPK” manufactured by Toagosei Co., Ltd.) was prepared. As the dispersion medium, ion-exchange water was prepared.

The solid content ratio of the raw materials was active material/conducting agent (AB)/thickener (CMC)/binder (fluorinated acrylic binder)/water-soluble polymer (PA) having an acidic functional group (mass ratio)=91−x/8/0.5/0.5/x (the amount of PA is expressed as x). In each of the examples, the addition amount of the PA (the amount of PA in the solid content of the electrode mixture) is shown in Table 1 of FIG. 5.

In Examples 1 to 4 and Comparative Examples 3 and 4, the solid content fraction in the electrode mixture was 75 mass %. In Comparative Examples 1 and 2, the solid content fraction in the electrode mixture was 60 mass %.

<Positive Electrode Mixture of Examples 1 to 4>

In Examples 1 to 4, as a kneading and granulating apparatus, a food processor (“MICHIBA KITCHEN PRODUCT MASTER MIX MB-MM91” manufactured by Yamamoto Electric Corporation) was prepared. As illustrated in FIG. 3A, the active material, the conducting agent (AB), and the thickener (CMC) were put into the kneading and granulating apparatus, and stirred at a high speed of 3000 rpm for 120 seconds. Next, the binder (fluorinated acrylic binder) and the water were added and stirred at a low speed of 800 rpm for 15 seconds, thereby obtaining granules having a median diameter D50 of 100 μm or greater. The water-soluble polymer (PA) having an acidic functional group was added to the obtained granules, and stirred at a high speed of 3000 rpm for 3 seconds, thereby obtaining a positive electrode mixture having a solid content fraction of 75 mass %.

<Positive Electrode Mixture of Comparative Examples 1 and 2>

In Comparative Examples 1 and 2, as a paste kneading apparatus, DISPER (LABOLUTION manufactured by PRIMIX Corporation) was prepared. To water, a powder mixture of the active material, the conducting agent (AB), the thickener (CMC), and the water-soluble polymer (PA) having an acidic functional group were added and dispersed, and thereafter water and the binder (fluorinated acrylic binder) were added and kneaded by using the kneading apparatus, thereby obtaining a paste-like positive electrode mixture having a solid content fraction of 60 mass %.

<Positive Electrode Mixture of Comparative Example 3>

In Comparative Example 3, the same kneading and granulating apparatus as in Examples 1 to 4 was prepared. As illustrated in FIG. 3B, the active material, the conducting agent (AB), the thickener (CMC), and the water-soluble polymer (PA) having an acidic functional group were put into the kneading and granulating apparatus, and stirred at a high speed of 3000 rpm for 120 seconds. Next, the binder (fluorinated acrylic binder) and the water were added and stirred at a low speed of 800 rpm for 15 seconds, thereby obtaining granules having a median diameter D50 of 100 μm or greater. The obtained granules were further stirred at a high speed of 3000 rpm for 3 seconds, thereby obtaining a positive electrode mixture having a solid content fraction of 75 mass %.

<Positive Electrode Mixture of Comparative Example 4>

In Comparative Example 4, the same kneading and granulating apparatus as in Examples 1 to 4 was prepared. As illustrated in FIG. 3C, the active material, the conducting agent (AB), and the thickener (CMC) were put into the kneading and granulating apparatus, and stirred at a high speed of 3000 rpm for 120 seconds. Next, the binder (fluorinated acrylic binder) and the water-soluble polymer (PA) having an acidic functional group were added and stirred at a low speed of 800 rpm for 15 seconds, thereby obtaining granules having a median diameter D50 of 100 μm or greater. The obtained granules were further stirred at a high speed of 3000 rpm for 3 seconds, thereby obtaining a positive electrode mixture having a solid content fraction of 75 mass %.

<Positive Electrode>

The electrode mixture obtained in each of Examples 1 to 4 and Comparative Examples 3 and 4 was formed on a current collector formed of an aluminum foil through rolling by using the film-forming apparatus including the three rolls as illustrated in FIG. 2, and the formed electrode mixture layer was dried such that a positive electrode was manufactured. The paste-like electrode mixture obtained in each of Comparative Examples 1 and 2 was applied onto the current collector formed of the aluminum foil by using a coating die, and the result was dried and pressed, such that a positive electrode was manufactured.

<Negative Electrode>

A paste-like electrode mixture containing graphite as the active material, styrene-butadiene copolymer (SBR) latex as the binder, carboxymethylcellulose (CMC) as the thickener, and ion-exchange water as the dispersion medium was obtained, and was applied onto a copper foil as the current collector, dried, and pressed, such that a negative electrode was manufactured.

<Separator>

A commercially available separator formed of a porous film having a three-layer laminate structure of polypropylene (PP)/polyethylene (PE)/polypropylene (PP) was prepared.

<Non-Aqueous Electrolyte>

LiPF₆, which is a lithium salt, as the electrolyte was dissolved in a solvent of ethylene carbonate (EC)/diethyl carbonate (DEC) having a volume ratio of 1/1 to have a concentration of 1 mol/L, such that a non-aqueous electrolyte was prepared.

<Manufacturing of Lithium-Ion Secondary Battery>

A battery cell was manufactured by a well-known method using the positive electrode obtained in each of Examples 1 to 4 and Comparative Examples 1 to 4, the negative electrode, the separator, and the laminated type exterior body. Thereafter, the non-aqueous electrolyte was injected into the cell, such that the lithium-ion secondary battery was manufactured.

Main manufacturing conditions of each of the examples are shown in Table 1 of FIG. 5.

(Evaluation Method)

<Corrosion Evaluation of Aluminum Foil>

After the positive electrode mixture was formed on the aluminum foil, before drying of the result, the formed electrode mixture layer was washed with water, and a surface of the exposed aluminum foil on the formation side was observed by a scanning electron microscope (SEM). A corrosion state was evaluated according to the following determination criteria. (Unavailable): corrosion is present over the entire surface, (Available): corrosion is partially present, and (Good): corrosion is absent over the entire surface.

<Evaluation of Battery Resistance>

A charge/discharge test was conducted on the obtained lithium-ion secondary battery, and the IV resistance thereof was measured. The battery resistance was evaluated according to the following determination criteria. (Good): IV resistance is lower than 2.0 mΩ, (Available): IV resistance is 2.0 mΩ or higher and lower than 2.4 mΩ, and (Unavailable): IV resistance is 2.4 mΩ or higher.

(Evaluation Results)

The evaluation results of each of the examples are shown in Table. 1 of FIG. 5. SEM pictures of the surfaces of positive electrode current collectors in the main examples are shown in FIGS. 4A and 4B.

In Examples 1 to 4, the positive electrode was manufactured by using the electrode mixture formed of the granules containing 0.1 mass % to 1.0 mass % of the water-soluble polymer (PA) having an acidic functional group added to the solid content. In Examples 1 to 4, the water-soluble polymer (PA) having an acidic functional group was added after granulation. In Examples 1 to 4, compared to Comparative Examples 1 to 4, an effect of suppressing the corrosion of the positive electrode current collector, and an effect of reducing the battery resistance of the lithium-ion secondary battery are obtained.

It is thought that, in Examples 1 to 4, the moisture content in the electrode mixture was lower than that of the paste-like electrode mixture, the reaction between the active material and the water in the electrode mixture was suppressed, and thus, the increase in the pH of the electrode mixture was suppressed. In addition, it is thought that, since the water-soluble polymer (PA) having an acidic functional group was added after the granulation, the water-soluble polymer (PA) having an acidic functional group could effectively be allowed to be present on the surface of each particle of the granules. Therefore, it is thought that, even when the addition amount of the water-soluble polymer (PA) having an acidic functional group was low, the water-soluble polymer (PA) having an acidic functional group could effectively be allowed to be present at the contact interface between the electrode mixture and the current collector. It is thought that, since the addition amount of the water-soluble polymer (PA) having an acidic functional group was low, the active material is prevented from being excessively coated with the water-soluble polymer (PA) having an acidic functional group, and thus, an increase in the battery resistance due to the coating of the active material was prevented. Particularly, in Examples 2 to 4 in which the addition amount of the water-soluble polymer (PA) having an acidic functional group was 0.2 mass % to 1.0 mass % in the solid content, the corrosion of the positive electrode current collector was effectively suppressed, and thus, the effect of reducing the battery resistance of the lithium-ion secondary battery was significant.

In Comparative Example 1, the positive electrode was manufactured by using the paste-like electrode mixture containing 1.0 mass % of the water-soluble polymer (PA) having an acidic functional group added to the solid content. In Comparative Example 1, the corrosion of the positive electrode current collector was significant, and the battery resistance of the lithium-ion secondary battery was also high. It is thought that in Comparative Example 1, the moisture content in the electrode mixture was high, and thus, a pH increase was significant due to the reaction between the electrode active material and the water in the electrode mixture. In addition, it is thought that since the water-soluble polymer (PA) having an acidic functional group was substantially homogeneously dispersed in the electrode mixture, the amount of the water-soluble polymer (PA), having an acidic functional group of 1.0 mass % added to the solid content, present at the contact interface between the electrode mixture and the current collector was insufficient.

In Comparative Example 2, the positive electrode was manufactured by using the paste-like electrode mixture containing 2.0 mass % of the water-soluble polymer (PA) having an acidic functional group added to the solid content. In Comparative Example 2, although the corrosion of the positive electrode current collector was suppressed, the battery resistance of the lithium-ion secondary battery was high. It is thought that in Comparative Example 2, the moisture content in the electrode mixture was high as in Comparative Example 1, and thus, a pH increase was significant due to the reaction between the electrode active material and the water in the electrode mixture. Here, it is thought that since the addition amount of the water-soluble polymer (PA) having an acidic functional group was high, a sufficient amount of the water-soluble polymer having an acidic functional group was present at the contact interface between the electrode mixture and the current collector. However, it is thought that since the addition amount of the water-soluble polymer (PA) having an acidic functional group was increased, the active material was excessively coated with the water-soluble polymer (PA) having an acidic functional group, resulting in an increase in the battery resistance.

In Comparative Examples 3 and 4, the positive electrode was manufactured by using the electrode mixture formed of the granules containing 0.5 mass % of the water-soluble polymer (PA) having an acidic functional group added to the solid content. Here, in Comparative Examples 3 and 4, unlike Examples 1 to 4, the water-soluble polymer (PA) having an acidic functional group was added before the granulation. In Comparative Examples 3 and 4, the corrosion of the positive electrode current collector was significant, and the battery resistance of the lithium-ion secondary battery was also high. It is thought that in Comparative Examples 3 and 4, since the water-soluble polymer (PA) having an acidic functional group was added before the granulation, the water-soluble polymer (PA) having an acidic functional group was substantially homogeneously dispersed in the electrode mixture, and the amount of the water-soluble polymer (PA), having an acidic functional group of 0.5 mass % added to the solid content, present at the contact interface between the electrode mixture and the current collector was insufficient.

What is claimed is:

1. A manufacturing method of an electrode comprising:
manufacturing an electrode mixture including granules containing an electrode active material, a binder, a water-soluble polymer having an acidic functional group, and a dispersion medium containing water; and
forming the electrode mixture on a current collector through rolling, wherein
the manufacturing of the electrode mixture includes forming granules containing the electrode active material, the binder, and the dispersion medium, and adding the water-soluble polymer having the acidic functional group to the granules.

2. The manufacturing method according to claim 1, wherein
during the adding of the water-soluble polymer, an amount of the water-soluble polymer having the acidic functional group in a solid content of the electrode mixture is 0.2 mass % to 1.0 mass %.

3. The manufacturing method according to claim 1, wherein
during the forming of the granules, the granules having a median diameter D50 of 100 μm or greater are formed.

4. The manufacturing method according to claim 1, wherein
the water-soluble polymer having the acidic functional group is at least one type selected from the group consisting of carboxymethyl starch, starch phosphate, alginic acid, polyacrylic acid, polymethacrylic acid, and polystyrene sulfonic acid.

5. The manufacturing method according to claim 1, wherein
the electrode active material contains a lithium-containing complex oxide.

6. The manufacturing method according to claim 1, wherein
the electrode is for a non-aqueous electrolyte secondary battery.
